(19) United States
(12) Patent Application Publication
(10) Pub. No.: US 2016/0156569 A1
(43) Pub. Date: Jun. 2, 2016

(54) Node and Method of Assigning Node to Space

(71) Applicant: Igor, Inc., Johnston, IA (US)

(72) Inventor: Dwight L. Stewart, Johnston, IA (US)

(73) Assignee: Igor, Inc., Johnston, IA (US)

(21) Appl. No.: 14/556,025

(22) Filed: Nov. 28, 2014

(51) Int. Cl. H04L 12/911; H04L 12/751

(52) U.S. Cl. CPC H04L 47/72; H04L 45/02

(57) ABSTRACT

Example embodiments relate to node and a method of assigning a space to a node. Example embodiments are also related to systems that use the node and implement the method of assigning a space to the node.

### BACKGROUND

1. Field

Example embodiments relate to a node and a method of assigning the node to a space. Example embodiments also relate to systems that use the node and implement the method of assigning a node to a space.

2. Description of the Related Art

Power over Ethernet (PoE) describes a system in which power and data are provided to a device via Ethernet cabling. FIG. 1, for example, illustrates a system 90 utilizing PoE. In FIG. 1 the system 90 includes three powered devices 50, 60, and 70 which may receive power and data from a switch 20. Typical examples of powered devices include IP cameras, IP telephones, wireless access points, switches, sensors, and light controllers. Though FIG. 1 shows only three powered devices 50, 60, and 70, it is understood the system 90 is usable to power and control only a single device, two devices, or more than three devices.

In the conventional art, the switch 20 may receive AC power and may distribute the power to a plurality of ports 25 to power the aforementioned devices. In FIG. 1, the switch 20 is illustrated as including twelve ports however it is understood that conventional switches 20 may include more than, or less than, twelve ports 25. Power from the ports 25 is delivered to the powered devices 50, 60, and 70 via conventional Ethernet cables 40.

In the conventional art, the switch 20 may include management software allowing the switch 20 to control how power is delivered to the powered devices 50, 60, and 70. For example, switch 20 may be configured to cycle power to the powered devices 50, 60, and 70. For example, in the event the devices 50, 60, and 70 are lights powered or controlled by the switch 20, the switch 20 may be configured to turn off the lights, or dim them, at times when they are not normally in use. In the alternative, the switch 20 may include a management port allowing an operator to configure the switch 20 or control the switch 20 to manage devices attached to the switch 20. For example, as shown in FIG. 1, the switch 20 may include a port allowing a user 10 to connect thereto to control the powered devices 50, 60, and 70 via the switch 20. In the conventional art, the switch 20 may alternatively be connected to a network which may be accessed by a user. In this latter embodiment, the user may have access to the switch 20, and may control the switch 20 via software that may run on the network or may run on a computer the user operates.

### SUMMARY

Example embodiments relate to a node and a method of assigning the node to a space. Example embodiments also relate to systems that use the node and implement the method of assigning a node to a space.

In accordance with example embodiments, a system may include a switch, a first node attached to the switch, a second node attached to the first node, and a computer configured to prompt a user to assign the first node to a space and then assign the the second node to the space.

In accordance with example embodiments a method may include prompting a user to assign a space to a first node and then using a computer to assign the space to any node connected to the first node.

### BRIEF DESCRIPTION OF THE DRAWINGS

Example embodiments are described in detail below with reference to the attached drawing figures, wherein:

FIG. 1 is a view of a conventional system employing PoE;

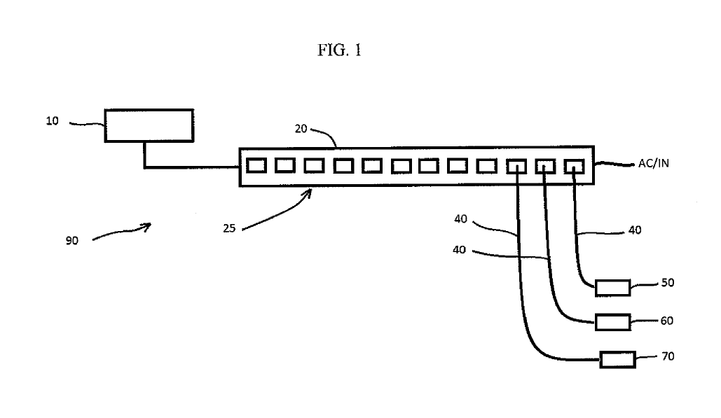

FIG. 2 is a view of a node in accordance with example embodiments;

FIGS. 3A and 3B are views of connected nodes in accordance with example embodiments;

FIG. 4 is a view of a system in accordance with example embodiments; and

FIG. 5 is a view of a floor plan in accordance with example embodiments

### DETAILED DESCRIPTION

Example embodiments will now be described more fully with reference to the accompanying drawings. Example embodiments are not intended to limit the invention since the invention may be embodied in different forms. Rather, the example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example Embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a node and a method of assigning the node to a space. Example embodiments also relate to systems that use the node and implement the method of assigning the node to a space.

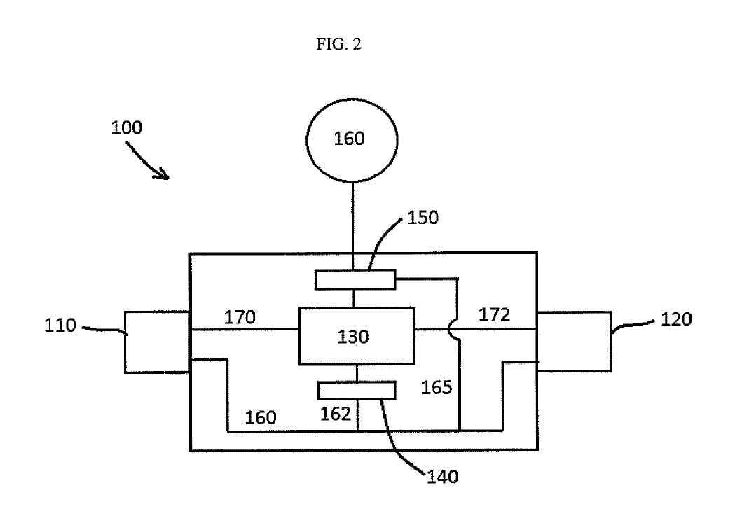

FIG. 2 is a view of a node 100 in accordance with example embodiments. As shown in FIG. 2, the node 100 may include an input port 110 and an output port 120. In example embodiments, each of the input port 110 and the output port 120 may be configured to receive a conventional PoE cord 40. Thus, the node 100 may be capable of receiving both data and power over PoE.

In Example embodiments, the node 100 may include a microprocessor 130. The microprocessor 130 may be configured to receive data from the input port 110, control a powered device 160 connected to the node 100, transmit data to the output port 120, receive data from the output port 120, and transmit data to the input port 110. Thus, in example embodiments, data may flow in two directions through the node 100.

In FIG. 2, the node 100 may include a first power source 140 configured to provide power to the microprocessor 130 and a second power source 150 configured to provide power to the powered device 160. In example embodiments, the first and second power sources 140 and 150 may be configured to receive power via conductive lines 160, 162, and 165 which may receive power from the input port 110. For example, when an Ethernet cable 40 is inserted into the input port 110, power may flow to the first power source 140 via the conductive lines 160 and 162 and may also flow to the second power source via conductive members 160 and 165. In example embodiments, the conductive member 160 may terminate at the output port 120. Thus, in example embodiments, power may also flow from the input port 110 to the output port 120 via the conductive member 160.

In FIG. 2, the microprocessor 130 may receive data from the input port 110. For example, in example embodiments, the microprocessor 130 may receive data via a conductive member 170. In example embodiments, the microprocessor 130 may use the data to control the powered device 160. In addition, or in the alternative, the microprocessor 130 may transfer the data to the output port 120 via another conductive member 172. In example embodiments, the microprocessor 130 may also be configured to receive data from the output port 120 and transfer this data to the input port 110. Thus, in example embodiments, data may flow two ways across the node 100.

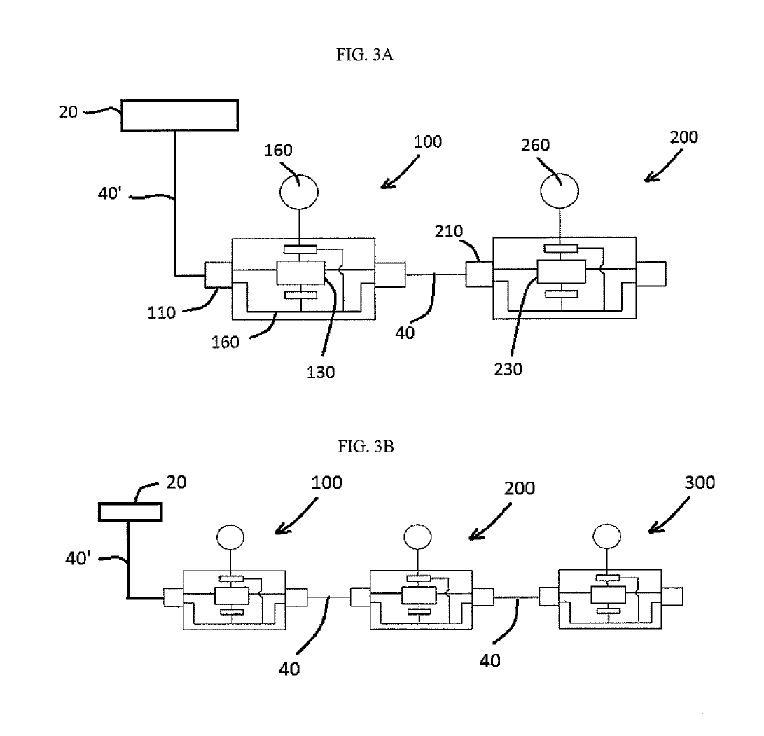

FIG. 3A illustrates two nodes 100 and 200 connected to one another. Because node 200 may be substantially identical to node 100, a detailed description thereof is omitted for the sake of brevity. In example embodiments, power and data may be provided to the input port 110 of node 100. For example, the input port 110 of node 100 may be connected to a conventional switch 20 via a PoE cable 40′. In example embodiments, the power from the switch 20 may flow along the conductive member 160 to the output port 120 and through the PoE cable 40 to the input port 210 of the second node 200. Thus, in example embodiments, power provided to the input port 110 may be used to power each of the first and second nodes 100 and 200. Similarly, data provided to the first port 110 may be provided to the processor 130 of the first node 100 and to the processor 230 of the second node 200. This data may allow the first node 100 to control the first powered device 160 and/or allow the second node 200 to control a second powered device 260. Also, in example embodiments, data may flow from the second node 200 to the first node 100 and from the first node 100 to the switch 20 via a PoE cable.

FIG. 3B illustrates three nodes 100, 200, and 300 connected to one another. In example embodiments the second and third nodes 200 and 300 may be substantially identical to the first node 100 and the principles associated with FIG. 3A apply to FIG. 3B. In other words, power and data from a switch 20 may flow to the input port 110 of the first node and the power and data may be provided to the second and third nodes 200 and 300 via PoE cables. Also, data may flow from the first node 100 to the second node 200 and then the third node and may also flow from the third node 300 to the second node 200, from the second node 200 to the first node 100, and from the first node 100 to the switch 20.

In example embodiments, each node may have a unique identifier built in. For example, each of nodes 100, 200, and 300 may have a unique identifier electronically embedded therein. For example, node 100 may have a first identifier, node 200 may have a second identifier, and node 300 may have a third identifier and each of the first, second, and third identifiers may be unique.

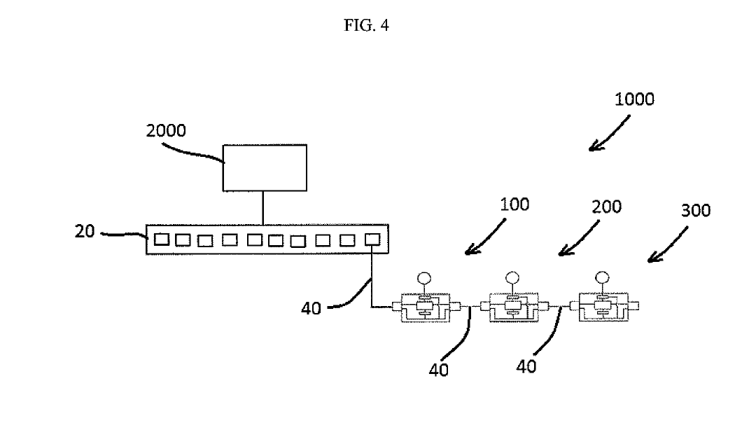

FIG. 4 is a view of a system 1000 in accordance with example embodiments. In FIG. 4, the system 1000 includes a computer 2000, a switch 20, a PoE cables 40, and the first node 100. In example embodiments, the computer 2000 may include software configured to associate a node with a physical space, for example, a room or a hallway of a building. In example embodiments, the computer 2000 may send a discovery signal to the switch 20 which may send the signal to all nodes attached to the switch 20. For example, in FIG. 4, the computer 2000 may cause a discovery signal to be sent to the node 100. The microprocessor 130 of the node 100 may return its unique identifier to the computer 2000. In example embodiments, a user may assign the node 100 to a space. In example embodiments, if the second node becomes attached to the first node 100, the second node may send its unique identifier to the computer 2000 and the software may assign the second node 200 to the first space associated with the first node 100. In example embodiments, if the third node 300 is attached to the second node, as shown in FIG. 3B, the third node 300 may send its unique identifier to the computer 2000 and the software may automatically assign the third node 300 to the space associated with the first node 100. In other words, in example embodiments, the software may prompt a user to associate a space with a first node and then assign the same space to all other nodes attached to the first node.

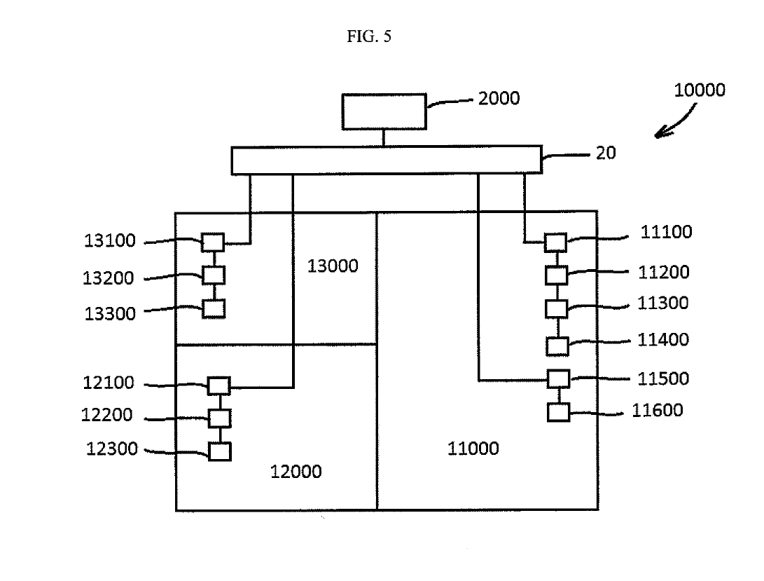

FIG. 5 is a view of a floor plan 10,000 of a building. The floor plan 10,000 includes three rooms 11000, 12000, and 13000. In example embodiments, each of the rooms 11000, 12000, and 13000 may constitute a separate space in a virtual model controlled by software loaded on the computer 2000. In FIG. 5, each of the rooms 11000, 12000, and 13000 includes nodes in accordance with example embodiments and each node may power a device, for example, a light. For example, room 11000 includes six nodes 11100, 11200, 11300, 11400, 11500, and 11600, room 12000 includes three nodes 12100, 12200, and 12300, and room 13000 includes three nodes 13100, 13200, and 13300. In example embodiments, each of the nodes 11100, 11200, 11300, 11400, 11500, 11600, 12100, 12200, 12300, 13100, 13200, and 13300 may resemble the node 100 having the powered device 160, thus, detailed descriptions thereof are omitted for the sake of brevity.

In example embodiments, each of the nodes 11100, 11200, 11300, 11400, 11500, 11600, 12100, 12200, 12300, 13100, 13200, and 13300 may receive power from the switch 20. For example, as shown in FIG. 5, the nodes 11100, 11500, 12100, and 13100 may receive power from different ports in the switch 20. Nodes 11200, 11300, 11400 may receive power from node 11100, node 11600 may receive power from node 11500, nodes 12200 and 12300 may receive power from node 12100, and nodes 13200 and 13300 may receive power from node 13100.

In example embodiments, software may be provided on a computer 2000 to manage the nodes in each room. The software may provide a virtual model of the floor plan illustrated in FIG. 5. For example, the software may allow a user to define room 11000 as a first space, room 12000 as a second space, and room 1300 as a third space. For example, in example embodiments, the computer 2000 may be connected to a network which in turn is connected to the switch 20. In example embodiments the software may cause a discovery signal to be output to the switch 20 so that the software can detect each of the nodes 11100, 11200, 11300, 11400, 11500, 11600, 12100, 12200, 12300, 13100, 13200, and 13300. The nodes may return their unique identifiers to the computer 2000. In example embodiments, the software may prompt the user to assign a node, for example node 11100, to a space. For example, a user may assign node 11100 to space 11000. In example embodiments, because nodes 11200, 11300, and 11400 are attached to node 11100, the software may automatically assign nodes 11200, 11300, and 11400 to space 11000. Similarly, the software may prompt a user to assign node 11500 to a space in which case the user may assign node 11500 to space 11000. Because node 11600 is attached to node 11500, the software may automatically assign space 11000 to node 11600. Similarly, the software may prompt a user to assign node 12100 to a space in which case the user may assign node 12100 to space 12000. Because nodes 12200 and 12300 are attached to node 12100, the software may automatically assign space 12000 to nodes 12200 and 12300. Similar yet, the software may prompt a user to assign node 13100 to a space in which case the user may assign node 13100 to space 13000. Because nodes 13200 and 13300 are attached to node 13100, the software may automatically assign space 13000 to nodes 13200 and 13300.

In example embodiments, at least one node in a group of nodes may be assigned a space by a user. However, in example embodiments, the user may not be required to assign a space to the remaining nodes in the group of nodes since the software may be configured to automatically assign the same space to the remaining nodes in the group of nodes. This aspect of example embodiments greatly reduces the amount of input required by a user. For example, as shown in FIG. 5, four groups of nodes may be attached to the switch 20. In this case, however, a user would only be prompted to enter a space for nodes, 11100, 11500, 12100, and 13100, rather than for all twelve nodes illustrated in FIG. 5. Also, in example embodiments, after all nodes have been assigned a space, additional nodes may be added and the software may automatically assign a space to the added node. For example, if another node were attached to node 12300, the software may detect the newly added node and assign the space 12000 to the newly added node.

In example embodiments, nodes which are physically connected to one another may be assigned to a same space in a virtual model. In example embodiments, the software may be configured so that if any one node within a group of physically connected nodes has a reassigned space that all nodes attached to that node may also be reassigned to the new space. For example, if nodes 13100, 13200, and 13300 were originally assigned to space 13000 and if a user reassigned node 13200 to space 11000, then the software may automatically reassign nodes 13100 and 13300 to space 11000.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A system comprising:
a switch;
a first node attached to the switch;
a second node attached to the first node; and
a computer configured to prompt a user to assign the first node to a space and then assign the second node to the space.

2. The system of claim 1, wherein the computer is further configured to reassign one of the first node and the second node to a second space when the other of the first node and the second node is reassigned to the second space.

3. The system of claim 1, wherein the computer is configured to model a plurality of virtual spaces which correspond to a plurality of physical spaces and send a discovery signal to nodes within the plurality of physical spaces.

4. The system of claim 1, wherein the first and second nodes are serially connected.

5. The system of claim 1, wherein the first node is configured to receive a signal and retransmit the signal to the second node.

6. A method comprising:
defining a plurality a spaces that correspond to physical spaces;
prompting a user to assign a first node to one of the plurality of spaces; and
using a computer to assign a second node to the one of the plurality of spaces, wherein the second node is connected to the first node.

7. The method of claim 6, further comprising:
reassigning one of the first node and the second node to another space of the plurality of spaces when the other of the first node and the second node is reassigned to the another space.

8. The method of claim 6, further comprising:
sending a discovery signal to nodes within the plurality of physical spaces.

9. The method of claim 6, further comprising:
serially connecting the first node to the second node.

10. The method of claim 6, further comprising:
retransmitting a signal received by the first node to the second node.
